(19) United States
(12) Patent Application Publication
(10) Pub. No.: US 2019/0232096 A1
(43) Pub. Date: Aug. 1, 2019

(54) EARLY FIRE DETECTION WITH LASER-BASED SENSOR AND 2D INFORMATION MAPPING FOR HIGH CEILING BUILDINGS

(71) Applicant: NEC Laboratories America, Inc., Princeton, NJ (US)

(72) Inventor: Ming-Fang Huang, Princeton, NJ (US)

(21) Appl. No.: 16/229,505

(22) Filed: Dec. 21, 2018

Related U.S. Application Data
(60) Provisional application No. 62/622,174, filed on Jan. 26, 2018.

(51) Int. Cl. A62C 37/36; A62C 3/00; G01N 21/61

(52) U.S. Cl. CPC A62C 37/36; G01N 21/61; A62C 3/00; A62C 37/04

(57) ABSTRACT

A fire detection system and method for fire detection are provided. The fire detection system includes at least one light emitting device for emitting light in a two-dimensional arrangement having multiple optical paths. The fire detection system further includes at least one light detection device for outputting respective light detection signals responsive to detecting the emitted light in each of the multiple optical paths of the two-dimensional arrangement. The fire detection system also includes a controller for identifying an abnormal condition relating to an early fire condition and initiating a set of fire sprinklers responsive to the respective light detection signals.

### RELATED APPLICATION INFORMATION

This application claims priority to U.S. Prov. Pat App. Ser. No. 62/622,174, filed on Jan. 26, 2018, incorporated herein by reference herein its entirety.

### BACKGROUND

### Technical Field

The present invention relates to fire detection systems and more particularly to early fire detection with a laser-based sensor and 2D information mapping for high ceiling buildings.

### Description of the Related Art

To ensure safe fire-fighting operation and quick evacuation in buildings, fire detection systems play an important role. Accurate and quick detection on any signal of fire is crucial to reduce the risk of fatality and damage to the property. The current generation of fire detection systems is designed to respond to the smoke, heat, or the electromagnetic radiation generated during smoldering and flaming combustion. The typical accidental fire begins as a slow growth, smoldering process which may last from a few minutes to several hours.

For most fires, sprinklers utilize water by direct application onto flames and heat. Each sprinkler is operated by actuation of its own temperature (typically in excess of 51-107° C./132-225° F.), and distributes water over a defined area (typically 41-21 m²/150-225 ft²) [2-4].

There is an urgent need to detect indoor fires in their early stage, especially places with high ceiling where people gather (i.e. stadiums, airports, convention centers, warehouses, and so forth).

### SUMMARY

According to an aspect of the present invention, a fire detection system is provided. The fire detection system includes at least one light emitting device for emitting light in a two-dimensional arrangement having multiple optical paths. The fire detection system further includes at least one light detection device for outputting respective light detection signals responsive to detecting the emitted light in each of the multiple optical paths of the two-dimensional arrangement. The fire detection system also includes a controller for identifying an abnormal condition relating to an early fire condition and initiating a set of fire sprinklers responsive to the respective light detection signals.

According to another aspect of the present invention, a method is provided for fire detection. The method includes emitting, by at least one light emitting device, light in a two-dimensional arrangement having multiple optical paths. The method further includes outputting, at least one light detection device, respective light detection signals responsive to detecting the emitted light in each of the multiple optical paths of the two-dimensional arrangement. The method also includes identifying, by a controller, an abnormal condition relating to an early fire condition and initiating, by the controller, a set of fire sprinklers, responsive to the respective light detection signals.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary architecture for indoor early fire detection, in accordance with an embodiment of the present invention;

FIG. 2 is a block diagram showing another exemplary architecture for indoor early fire detection, in accordance with an embodiment of the present invention;

FIG. 3 is a block diagram showing yet another exemplary architecture for indoor early fire detection, in accordance with an embodiment of the present invention;

FIG. 4 is a block diagram showing still another exemplary architecture for indoor early fire detection, in accordance with an embodiment of the present invention;

FIG. 5 is a block diagram showing yet another exemplary architecture for indoor early fire detection, in accordance with an embodiment of the present invention;

FIG. 6 is a block diagram showing a further exemplary architecture for indoor early fire detection, in accordance with an embodiment of the present invention;

FIG. 7 is a block diagram showing a still further exemplary architecture for indoor early fire detection, in accordance with an embodiment of the present invention;

FIG. 8 is a block diagram showing a yet further exemplary architecture for indoor early fire detection, in accordance with an embodiment of the present invention;

FIG. 9 is a block diagram showing an exemplary processing system to which the present invention may be applied, in accordance with an embodiment of the present invention; and

FIG. 10 is a flow diagram showing an exemplary method for fire detection, in accordance with an embodiment of the present invention.

### DETAILED DESCRIPTION OF PREFERRED EMBODIMENTS

The present invention is directed to early fire detection with a laser-based sensor and two-dimensional (2D) information mapping for high ceiling buildings.

In one or more embodiments, the present invention can use long-range gas sensing systems and 2D information mapping for indoor early fire detection, especially in high ceiling buildings. This can provide a spatial mapping of gas concentration and optical transmission loss over a large area. In an exemplary embodiment of the present invention, both horizontal and longitudinal sensing results can be provided via a maneuverable sensor head and/or a fiber switching technique to locate an abnormal point. In an embodiment, a Software Defined Network (SDN)-controlled sprinkler can be interconnected to long-range gas sensing systems.

In one or more embodiments, on the sensor side, trace gas sensing can provide gas concentration and optical intensity information along a light path (i.e., horizontal). Adding another direction of sensing information (i.e. longitudinal) in 2D spatial mapping, the abnormal situation can be located in its early stage.

In one or more embodiments, on the sprinkler side, a software controlled motor is interconnected to a sensor controller. After detecting an abnormal situation (e.g., more CO than usual or relative to a threshold, a higher CO₂ concentration than usual or relative to a threshold, a large optical transmission loss, and so forth) by gas sensors in the early stages of a fire, sprinklers can be activated before flaming occurs. The sprinkler system can include features such as, for example, but not limited to, opening and closing control valves, controlling fire pump operation, and controlling both high and low air pressure on dry-pipe sprinkler systems. Comparing to traditional sprinklers, the proposed sprinkler system applies concentrated water onto the target (ignition point) using a maneuverability motor and provides effective fire extinguishing in a smaller area.

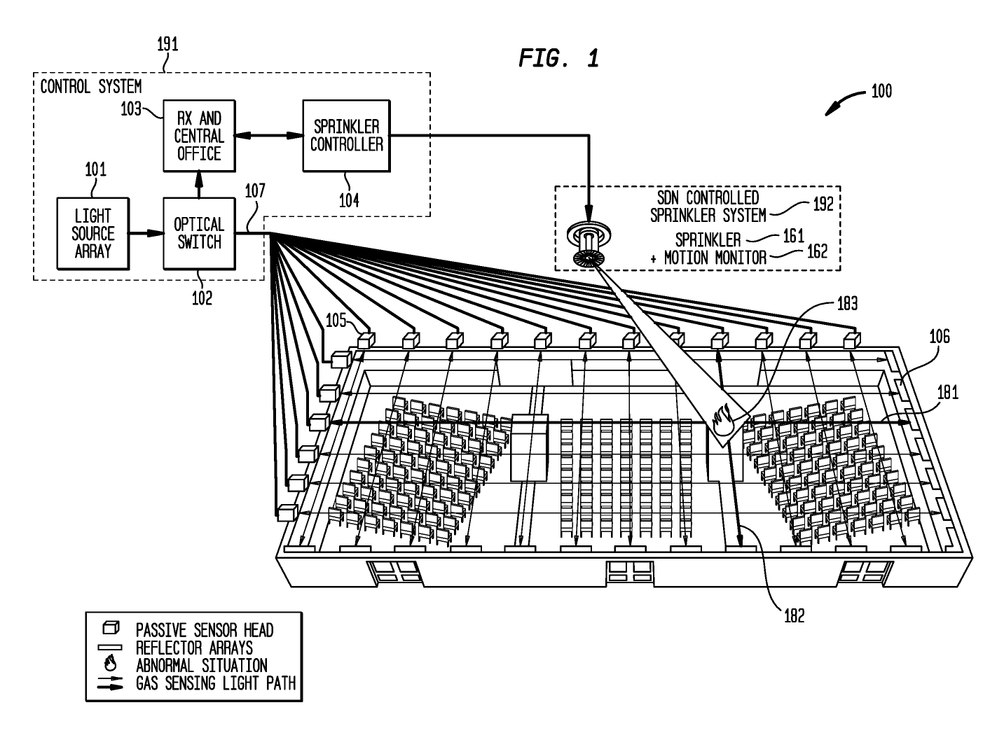

In order to improve sensitivity and reduce false alarms for indoor fire detection, various illustrative architectures are shown in FIGS. 1-8 relative to 8 exemplary embodiment of the present invention. TABLE 1 describes the following information (1) applicable figure number from FIGS. 1-8; (2) upper ceiling elements used, if any; (3) lower side of the room elements used; (4) an overall description of the approach used in that embodiment; and (5) an indication of whether the light path makes a round trip or is used in a single pass mode.

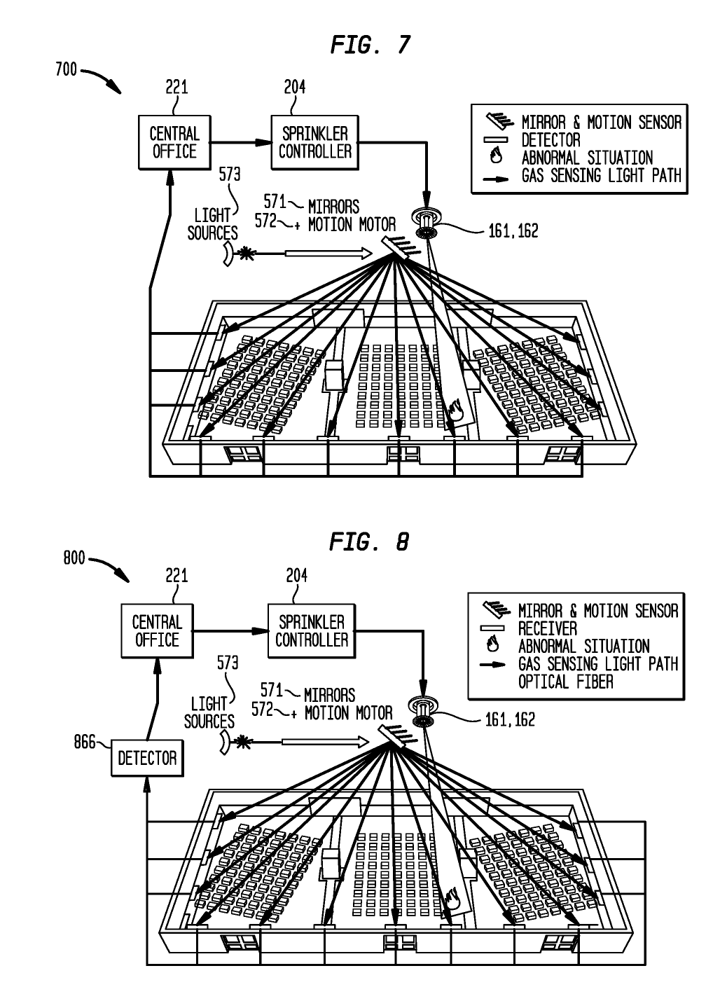

TABLE 1

| | | LOWER | | |
|---|---|---|---|---|
| | UPPER | (SIDE OF | | LIGHT |
| FIG. | (CEILING) | ROOM) | DESCRIPTION | PATH |
| 1 | N/A | Passive | (1) Optical switching technology. | Round |
| | | sensor | (2) Employing optical fiber to deliver | trip |
| | | head/ | signals from control room to sensor heads. | |
| | | reflector | (3) The receiving signals are sending back | |
| | | arrays | to the control room by same optical fiber. | |
| 2 | Lamp + | Receiver + | (1) Low cost solution using lamp light. | Single |
| | motion | filter | (2) Low cost detector with filter. | pass |
| | motor | | | |
| 3 | N/A | Sensor | (1) Delivering received signals to the | Single |
| | | head/ | detector by optical fiber. | pass |
| | | receiver | (2) Light Sources can be shared using an | |
| | | | optical switch or individual. | |
| 4 | N/A | Light | (1) Delivering received signals to the | Single |
| | | source/ | detector by optical fiber. | pass |
| | | receiver | (2) Light Sources can be shared using an | |
| | | | optical switch or individual. | |
| 5 | Lamp + | Reflector | (1) If the light can be transmitted to each | Round |
| | motion | arrays | corner of the room, the motion motor is not | trip |
| | motor | | necessary. | |
| | (if needed) | | (2) The transceiver is located in central | |
| | | | office | |
| 6 | Detector + | Light | (1) Broadband light sources can be used for | Single |
| | filter | sources | lighting and sensing simultaneously. | pass |
| 7 | Mirror + | Detector + | (1) Shutting light sources (can be located on | Single |
| | motion | filter | the ceiling or in lower side) to the mirror. | pass |
| | motor | | (2) Employing motion motor to guide the | |
| | | | light to the detector on the floor for gas | |
| | | | sensing. | |
| | | | (3) One detector is employed to analyze the | |
| | | | data from the receivers received via optical | |
| | | | fiber. | |
| 8 | Mirror + | Receiver | (1) Shutting light sources (can be located on | Single |
| | motion | | the ceiling or in lower side) to the mirror. | pass |
| | motor | | (2) Employing motion motor to geode the | |
| | | | light to the detector on the floor for gas | |
| | | | sensing. | |
| | | | (3) Receivers can be used instead of | |
| | | | detectors in FIG. 7. One detector is | |
| | | | employed to analyze the data from the | |
| | | | receivers received via optical fiber. | |

While various implementations are shown relative to FIGS. 1-8, it is to be appreciated that various aspects of these implementation can be mixed as applicable to a given application. For example, elements from one or more other embodiments can be combined and/or otherwise integrated with a particular embodiment in order to achieve a certain level of detection, redundancy, and so forth, as readily appreciated by one of ordinary skill in the art given the teachings of the present invention provided herein, while maintaining the spirit of the present invention.

FIG. 1 is a block diagram showing an exemplary architecture 100 for indoor early fire detection, in accordance with an embodiment of the present invention.

The architecture 100 includes a light source array 101, an optical switch 102, a receiver (RX) and central office 103, a sprinkler controller 104, passive light emitting sensor heads (hereinafter “passive sensor heads” in short) 105, reflector arrays 106, and an optical fiber bundle 107. A gas sensing light path is shown using the various arrows, and an abnormal situation is shown using a flame as a representation thereof.

The architecture 100 further includes a control system 191 and a SDN controlled sprinkler system 192. The control system 191 is formed from the light source array 101, the optical switch 102, the RX and central office 103, and the sprinkler controller 104. The SDN controlled sprinkler system 192 is formed from a sprinkler 161 and a motion motor 162.

Flexible gas selectivity is achieved based on the varied light sources of the array 101. The light source array 101 can be formed from one or more of the following: Light-Emitting Diodes (LEDs); Distributed Feed-Back Laser Diodes (DFB-LDs) or Quantum Cascaded Lasers (QCLs) for smoke, oxygen (O₂), carbon dioxide (CO₂) and carbon monoxide (CO) sensing. The optical signal is transmitting to each passive sensor head 105 which is installed around the room via the optical switch 102. The passive sensor head 105 includes a telescope and optical fiber bundle to launch and collect the signals. The data signals are reflected from the reflector arrays 106 and detected by the receiver 103 through optical fiber bundle 107. Based on the gas concentration and optical transmission loss detection around the room, traced unusual gas concentration 181 and 182 will be detected as abnormal situations. Utilizing 2D gas information mapping, the ignition point 183 can be located.

The SDN controlled sprinkler system 192 is interconnected to the controller 104. Different from traditional sprinklers in a fixed position, the proposed sprinkler is working with a motion motor. Once the abnormal situation has been detected and located by gas sensor, the motion motor can guide the sprinkler for extinguishing with concentrated water before flame fire arising.

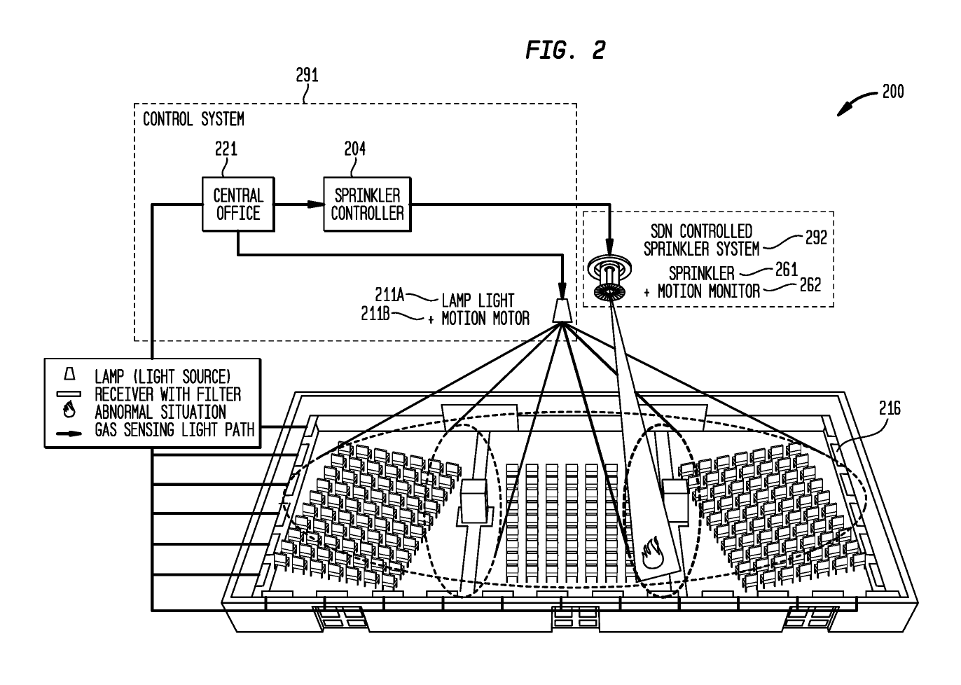

FIG. 2 is a block diagram showing another exemplary architecture 200 for indoor early fire detection, in accordance with an embodiment of the present invention.

In contrast to architecture 100 of FIG. 1 which uses a passive sensor head 105 to emit light and reflector arrays 106 to detect the emitted light, architecture 200 uses a lamp light 211A and motion motor 211B as a maneuverable sensor head to emit light and further uses receivers (with filters) 216 to detect the emitted light. Moreover, in contrast to architecture 100 of FIG. 1 which lacks an upper (ceiling) component, architecture 200 includes an upper component in order to detect an abnormal situation in the ceiling.

The environment 200 includes a sprinkler controller 204, a lamp light and motion motor 211, a central office 221, and receivers (with filters) 216.

The architecture 200 further includes a control system 291 and a SDN controlled sprinkler controller 292. The control system 291 is formed from the central office 221, the sprinkler controller 204, and the lamp light 211A and motion motor 211B. The SDN controlled sprinkler controller 292 is formed from a sprinkler 261 and a motion motor 262.

Instead of a light source array 101 with reflector arrays 106 as per architecture 100, a new transmitting and receiving scheme is proposed for architecture 200 involving a new light source 211. A broadband lamp 211A and a motion motor 211B are used to realize the new light source as a maneuverable sensor head 211. The motion motor is pre-programmed to ensure the signal can be detected by the receivers 216 installed around the room. Each receiver 216 has filters inside to receive target spectra. All of the detected signals will be collected and analyzed in central office 221. Once the abnormal situation has been detected and located, the SDN controlled sprinkler system 292 will be active via the sprinkler controller 204 guided by central office 221.

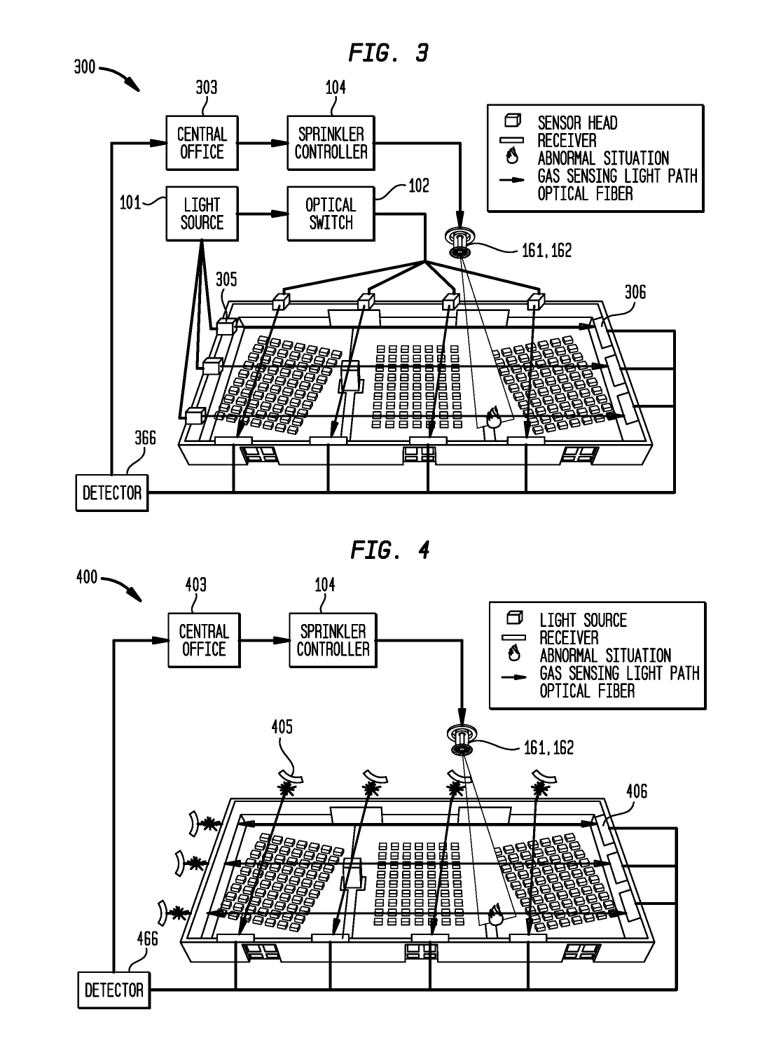

FIG. 3 is a block diagram showing yet another exemplary architecture 300 for indoor early fire detection, in accordance with an embodiment of the present invention. Architecture 300 is similar to architecture 100, except in architecture 300 all of the passive sensor heads 305 are connected to optical switch 102 not partially connected to light source 101. Also, receivers 306 are used in place of the reflector arrays 106 used in architecture 100. Also, central office 303 is used in place of the RX and central office 103 of architecture 100. Additionally, a detector 366 is used to collect the signals from the receivers 306 and forward the signals to the central office 303.

FIG. 4 is a block diagram showing still another exemplary architecture 400 for indoor early fire detection, in accordance with an embodiment of the present invention. Architecture 400 is similar to architecture 100, except architecture 400 uses a light source 405 and receivers 406 in place of the passive sensor heads 105 and the reflector arrays 106 used in architecture 100. Also, central office 403 is used in place of the RX and central office 103 of architecture 100. Additionally, a detector 466 is used to collect the signals from the receivers 406 and forward the signals to the central office 403.

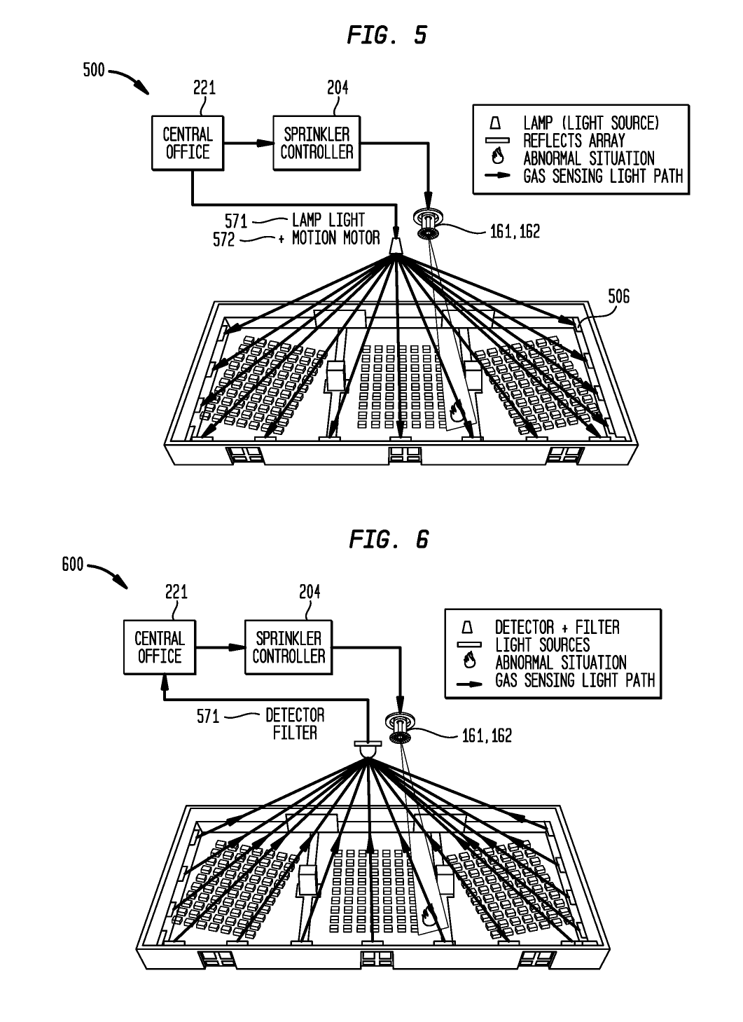

FIG. 5 is a block diagram showing yet another exemplary architecture 500 for indoor early fire detection, in accordance with an embodiment of the present invention. Architecture 500 is similar to architecture 200, except architecture 500 uses reflector arrays 506 in place of the receivers 216 used in architecture 200. Moreover, architecture 200 includes an upper component, in the form of at least a lamp (light source) 571 and motion motor 572, if needed, in order to detect an abnormal situation in the ceiling.

FIG. 6 is a block diagram showing a further exemplary architecture 500 for indoor early fire detection, in accordance with an embodiment of the present invention. Architecture 500 is similar to architecture 200, except architecture 500 uses light sources 561 in place of the lamp 211A, motion motor 211B, and receivers 216 used in architecture 200. Moreover, architecture 600 includes an upper component, in the form of at least detectors (with filters) 571, in order to detect an abnormal situation in the ceiling.

FIG. 7 is a block diagram showing a still further exemplary architecture 700 for indoor early fire detection, in accordance with an embodiment of the present invention. Architecture 700 is similar to architecture 200, except architecture 700 uses detectors with filters 561 in place of the receivers 216 used in architecture 200. Moreover, architecture 600 includes an upper component, in the form of at least mirrors 571, motion motors 572, and light sources 573 in order to detect an abnormal situation in the ceiling.

FIG. 8 is a block diagram showing a yet further exemplary architecture 800 for indoor early fire detection, in accordance with an embodiment of the present invention. Architecture 800 is similar to architecture 200, except architecture 800 uses at least mirrors 571, motion motors 572, and light sources 573 in place of the lamp 211A and motion motor 211B used in architecture 200, in order to detect an abnormal situation in the ceiling. Additionally, a detector 866 is used to collect the signals from the mirrors 571 and forward the signals to the central office 503.

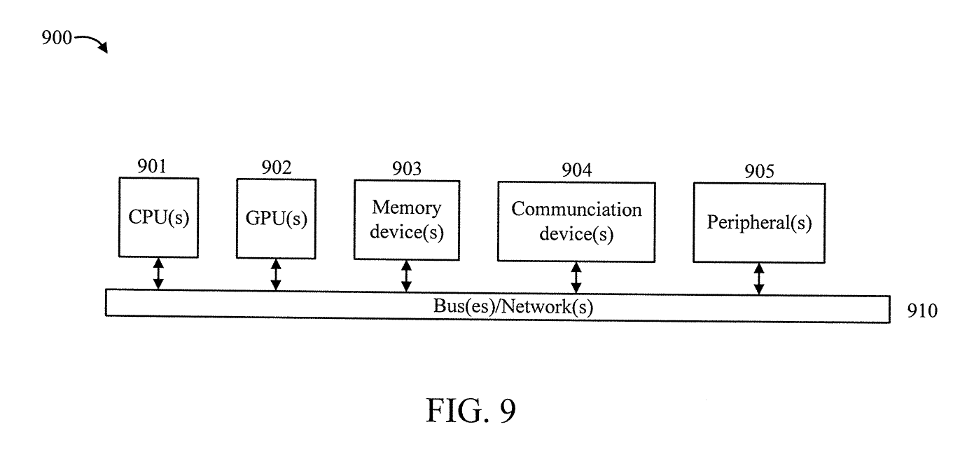

FIG. 9 is a block diagram showing an exemplary processing system 900 to which the present invention may be applied, in accordance with an embodiment of the present invention. The processing system 900 includes a set of processing units (e.g., CPUs) 901, a set of GPUs 902, a set of memory devices 903, a set of communication devices 904, and set of peripherals 905. The CPUs 901 can be single or multi-core CPUs. The GPUs 902 can be single or multi-core GPUs. The one or more memory devices 903 can include caches, RAMs, ROMs, and other memories (flash, optical, magnetic, etc.). The communication devices 904 can include wireless and/or wired communication devices (e.g., network (e.g., WIFI, etc.) adapters, etc.). The peripherals 905 can include a display device, a user input device, a printer, an imaging device, and so forth. Elements of processing system 900 are connected by one or more buses or networks (collectively denoted by the figure reference numeral 910).

Of course, the processing system 900 may also include other elements (not shown), as readily contemplated by one of skill in the art, as well as omit certain elements. For example, various other input devices and/or output devices can be included in processing system 900, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. Further, in another embodiment, a cloud configuration can be used. These and other variations of the processing system 900 are readily contemplated by one of ordinary skill in the art given the teachings of the present invention provided herein.

Moreover, it is to be appreciated that various figures as described above with respect to various elements and steps relating to the present invention that may be implemented, in whole or in part, by one or more of the elements of system 100. Moreover, one or more elements of system 900 may be used to control one or more elements of the various architectures described herein.

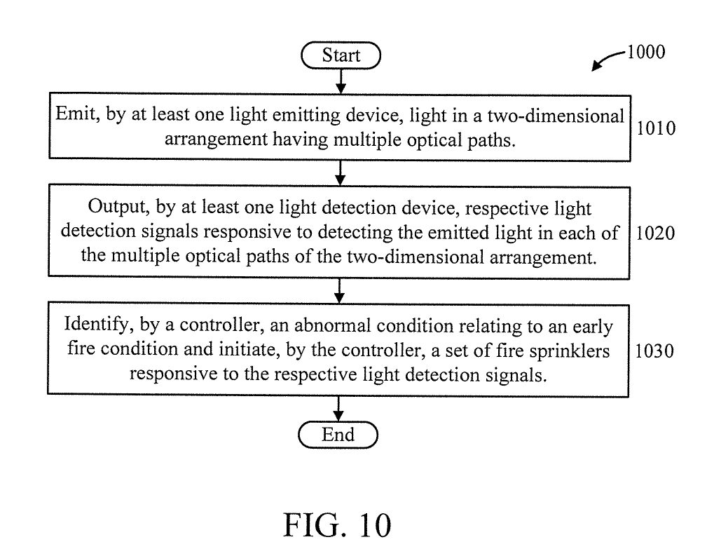

FIG. 10 is a flow diagram showing an exemplary method 1000 for fire detection, in accordance with an embodiment of the present invention.

At block 1010, emit, by at least one light emitting device, light in a two-dimensional arrangement having multiple optical paths. The light emitting device can be any of the light emitting devices described above with respect to any of FIGS. 1-8.

At block 1020, output, by at least one light detection device, respective light detection signals responsive to detecting the emitted light in each of the multiple optical paths of the two-dimensional arrangement. The light detecting device can be any of the light detecting devices described above with respect to any of FIGS. 1-8.

At block 1030, identify, by a controller, an abnormal condition relating to an early fire condition and initiate, by the controller, a set of fire sprinklers responsive to the respective light detection signals. The controller identifies the abnormal condition relating to the early fire condition by analyzing two-dimensional gas mapping data corresponding to the two-dimensional arrangement having the multiple light paths. In this way, the fire sprinklers can be deployed early in order to mitigate any resultant harm.

Thus, one or more embodiments of the present invention provide an indoor early fire detection system that uses 2D gas information (gas concentration, optical transmission loss) mapping to locate ignition point and extinguish the same in an early stage of the fire. In an embodiment, the present invention can provide a sensor set in a high ceiling building to provide promising performance and an increase in the accuracy of indoor early fire detection. The sensing part is implemented as a low-cost solution that uses 2D gas mapping information. A sprinkler part can include a SDN controlled system having a motion motor with concentrated water dispersion into targets for quick extinguishing.

Regarding the optical gas sensors used herein, the same can use a fiber switching technique where only one set of light source and detector are active at any given time. In an embodiment, a low cost reflector scheme can be used. In an embodiment, a maneuverable sensor head can be used with a low cost lamp with filter.

Further regarding the optical gas sensors used herein, the same provide high selectivity. For example, the same sensor head can be sued for multiple gas detection by changing light sources. For example, LED can be sued to detect O₂, NOx, etc., while DFB-LD can be used to detect CO₂, CO, H₂O, etc.

Still regarding the optical gas sensors used herein, the same can be used for varied applications. For example, different applications can be implicated based on light sources (sensitivity). For example, for air quality monitoring, DFB-LD can be used, while for fire detection, LED, lamp, and DFB-LD can be used.

Also, regarding the optical gas sensors used herein, the 2D gas mapping information can involve measuring line traced gas in longitudinal and horizontal directions for 2D has concentration mapping to identify an ignition point.

Regarding the sprinkler system used herein, the same provides a fast response in being controlled from the gas concentration results from a control system.

Further regarding the sprinkler system used herein, the same provide maneuverability in that motion motors guide sprinklers to an optimal position for fire extinguishing.

Also, regarding the sprinkler system, the same can provide concentrated water by direct application with water pipes of water onto abnormal points for efficient extinguishing.

The sensors employed can be of any type suitable for light and gas detection including, but not limited to photovoltaic devices, solar cells, and so forth. These and other sensors types can be readily used to implement the present invention, given the teachings of the present invention provided herein, while maintaining the spirit of the present invention.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A fire detection system, comprising:
at least one light emitting device for emitting light in a two-dimensional arrangement having multiple optical paths;
at least one light detection device for outputting respective light detection signals responsive to detecting the emitted light in each of the multiple optical paths of the two-dimensional arrangement; and
a controller for identifying an abnormal condition relating to an early fire condition and initiating a set of fire sprinklers responsive to the respective light detection signals.

2. The fire detection system of claim 1, wherein perturbances in any of the multiple optical paths of the two-dimensional arrangement are evaluated as potentially being the abnormal condition.

3. The fire detection system of claim 1, wherein the at least one light detection device is configured to detect the abnormal condition in a ceiling portion of a building structure.

4. The fire detection system of claim 1, further comprising an optical fiber bundle for delivering the light detection signals from the at least one light detector to the controller for evaluation.

5. The fire detection system of claim 4, wherein the optical fiber bundle sends the light to the at least one light emitting device for emission therefrom.

6. The fire detection system of claim 1, wherein the at least one light emitting device and the at least one light detecting device comprises an integrated passive light emitting and light detecting sensor head.

7. The fire detection system of claim 6, further comprise a reflector array for reflecting the emitted light back to the integrated passive light emitting and light detecting sensor head.

8. The fire detection system of claim 1, wherein the at least one light emitting device comprises an array of light emitting devices, and the fire detection system further comprises at least one optical switch for selectively enabling and disabling various ones of the light emitting devices in the array.

9. The fire detection system of claim 1, wherein the at least one light emitting device comprises a lamp and motion motor for selectively moving the lamp, and the at least one light detection device comprises a light receiver with a bandpass filter.

10. The fire detection system of claim 1, wherein the at least one light emitting device comprises a maneuverable light emitting sensor head, and the at least one light detection device comprises a light receiver.

11. The fire detection system of claim 1, wherein the at least one light emitting device and the at least one light detection device comprise an integrated broadband light source and detector configured for simultaneous light emission and detection.

12. The fire detection system of claim 1, wherein the at least one light emitting device comprises a light source configured for non-ceiling fire anomaly detection, the at least one light detecting device comprises a light detector with a bandpass filter for the non-ceiling fire anomaly detection, and wherein the fire detection system further includes a ceiling fire anomaly detection configuration comprises at least one light source, at least one mirror, at least one motion motor for selectively moving the at least one mirror, and at least one light detector.

13. The fire detection system of claim 1, wherein the set of fire sprinklers are comprised in a Software Defined Network.

14. The fire detection system of claim 13, wherein the Software Defined Network further comprises a motion motor for selectively moving the fire sprinklers.

15. The fire detection system of claim 13, wherein at least a portion of the Software Defined Network is implementing using a cloud-based configuration.

16. The fire detection system of claim 1, wherein the controller is configured to detect any of smoke, oxygen, carbon dioxide, and carbon monoxide.

17. The fire detection system of claim 1, wherein the multiple light paths are configured to provide round trips for the emitted light in each of the multiple light paths.

18. The fire detection system of claim 1, wherein the multiple light paths are configured to provide single pass trips for the emitted light in each of the multiple light paths.

19. The fire detection system of claim 1, wherein the controller identifies the abnormal condition relating to the early fire condition by analyzing two-dimensional gas mapping data corresponding to the two-dimensional arrangement having the multiple light paths.

20. A method for fire detection, comprising:
emitting, by at least one light emitting device, light in a two-dimensional arrangement having multiple optical paths;
outputting, at least one light detection device, respective light detection signals responsive to detecting the emitted light in each of the multiple optical paths of the two-dimensional arrangement; and
identifying, by a controller, an abnormal condition relating to an early fire condition and initiating, by the controller, a set of fire sprinklers, responsive to the respective light detection signals.
